(19) United States
(12) Patent Application Publication
(10) Pub. No.: US 2012/0223493 A1
(43) Pub. Date: Sep. 6, 2012

(54) Three-Dimensional Snowboard With Accompanying Goggles

(76) Inventor: Ezekiel Cortez, Denver, CO (US)

(21) Appl. No.: 13/037,468

(22) Filed: Mar. 1, 2011

(51) Int. Cl. A63C 5/00; G02B 27/22

(52) U.S. Cl. 280/14.22; 359/464

(57) ABSTRACT

A snowboard for enhanced visual effects comprising: a snowboard, where the snowboard includes a top surface; a three dimensional graphical image on the top surface; and a pair of three-dimensional goggles for use in conjunction with the snowboard and for viewing the graphical image.

### BACKGROUND OF THE INVENTION

1. Field of Invention

The present invention relates to a snowboard that includes three-dimensional imaging that is used in conjunction with three-dimensional visual goggles as a means to enhance snowboarding.

2. Description of Related Art

Snowboarding is a poplar winter sport where a participant descends a snow slope with the use of a snowboard attached to their feet using a special boot. The snowboard resembles a wide ski and enables the user to glide down a slope. The snowboard includes actual equipment such as bindings and special boots to secure the feet to the board so that the user may ride in a upright position. Opposite the binding side is the gliding surface of the snowboard that comes into contact with the snow during use. Snowboarding has become a popular sport and many ski slopes are crowded with both traditional skiers and snowboarders descending the slopes simultaneously. Snowboarding also has various competitions similar to skiing that include racing, freestyling, jump competitions and other popular competitions such as at the X-Games.

The binding surface of the board that is used to bind the user's boots into place includes bindings for the boots and additional spacing is available on each side of the bindings of the snowboard. Many times the snowboards are decorated in various colors and designs to enhance their aesthetic appearance. The additional spacing on the top of the snowboard is readily available for various designs, additional script or coloring that would not affect the functionality of the snowboard. It would be advantageous if this particular area could be used for optical effects that could enhance the snowboarder's experience.

### SUMMARY OF THE INVENTION

The present invention relates to a snowboard for enhanced visual effects comprising: a snowboard, where the snowboard includes a top surface; a three dimensional graphical image on the top surface; and a pair of three-dimensional goggles for use in conjunction with the snowboard and for viewing the graphical image.

### BRIEF DESCRIPTION OF DRAWINGS

FIG. 1 depicts a snowboard that includes three-dimensional imaging in accordance with the present invention.

### DETAILED DESCRIPTION

The present invention relates to three-dimensional visual imaging that is integrated into the top surface of a snowboard that is used in conjunction with three-dimensional goggles. The use of the three-dimensional goggles in conjunction with the three-dimensional imaging creates an interactive visual effect on the top surface of the snowboard. Use of the three-dimensional goggles with three-dimensional imaging on the snowboard provides an optical-enhanced view for the snowboarder.

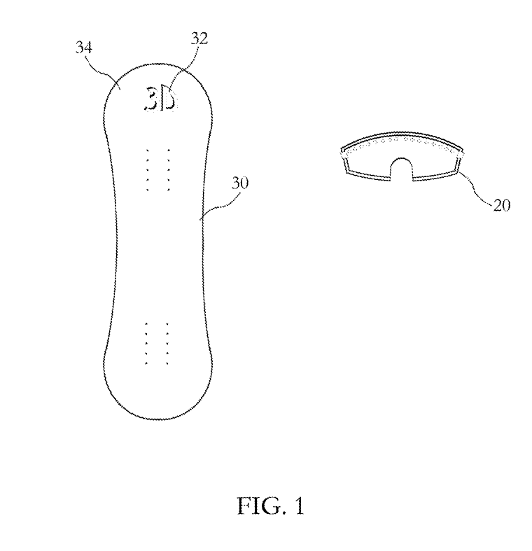

In reference to FIG. 1, a Snowboard 30 in accordance with the present invention is depicted. The Snowboard 30 includes a Three-Dimensional Graphic Image 32 placed on a Top Surface 34 of the Snowboard 30. This Graphic Image 32 is a three-dimensional visual effect image that intensifies and enhances the optical experience of the snowboarder. When used in conjunction with three-dimensional goggles according to the present invention the user may enjoy an interactive three-dimensional image while using the Snowboard 30.

Three-Dimensional Goggles 20 are also depicted in FIG. 1 that are used in conjunction with the Snowboard 30. The Goggles 20 enable a three-dimensional viewing capability so that the user of the Goggles 20 may capture the three-dimensional imaging on the Top Surface 34 of the Snowboard 30. The Three-Dimensional Graphic Image 32 is a three-dimensional optical projectile that may range 1 to 2 inches in length along the edge of the Snowboard 30. The Image 32 when viewed with Goggles 20 provides the user with a three-dimensional graphical experience unlike any other that may be enjoyed during a snowboarding run. The Goggles 20 also serve some of the traditional functions of ski goggles such as deflection of UV rays and for protective purposes while snowboarding. However the three-dimensional effect of the Goggles 20 when used with the Three-Dimensional Image 32 creates a unique graphical imaging experience for the snowboarder. The instant invention has been shown and described in what it considers to be the most practical and preferred embodiments. It is recognized, however, that departures may be made there from within the scope of the invention and that obvious modifications will occur to a person skilled in the art.

1. A snowboard for enhanced visual effects comprising:
a. a snowboard, where the snowboard includes a top surface;
b. a three dimensional graphical image on the top surface; and
c. a pair of three dimensional goggles for use in conjunction with the snowboard and for viewing the graphical image, where the pair of three dimensional goggles include UV ray protection.

2. The snowboard for enhanced visual effects according to claim 1, wherein the three dimensional graphical image ranges from 1 to 2 inches in length.

3. The snowboard for enhanced visual effects according to claim 1, wherein the three dimensional graphical image is positioned along an edge of the top surface of the snowboard.
